(19) United States
(12) Patent Application Publication
(10) Pub. No.: US 2004/0056971 A1
(43) Pub. Date: Mar. 25, 2004

(54) Thin type camera module

(75) Inventors: Charles Yang, Kaohsiung (TW); Allen Kuo, Kaohsiung (TW)

Correspondence Address: TROXELL LAW OFFICE PLLC, SUITE 1404, 5205 LEESBURG PIKE, FALLS CHURCH, VA, 22041, US

(73) Assignee: International Semiconductor Technology Ltd.

(21) Appl. No.: 10/660,649

(22) Filed: Sep. 12, 2003

(30) Foreign Application Priority Data
Sep. 23, 2002 (CN) 091215244

(51) Int. Cl. H04N 5/335

(52) U.S. Cl. 348/294

(57) ABSTRACT

A thin type camera module includes a fixing board, an imaging-sensing semiconductor assembly, and a lens holder. The image-sensing semiconductor assembly is manufacture by a chip-on-film (COF) packaging method. The image-sensing semiconductor assembly comprises an image sensing chip and a COF wiring film, wherein the image sensing chip is flip-chip mounted on the COF wiring film. A photosensitive surface of the image sensing chip is corresponding to a window of the COF wiring film and disposed toward a light-pervious channel of the lens holder. The lens holder is connected with the fixing board to form an airtight space for sealing the image sensing chip. The COF wiring film has a module circuit for mounting an electrical device.

### FIELD OF THE INVENTION

The present invention is relating to a camera module, particularly to a thin type camera module comprises an image-sensing semiconductor assembly manufactured by Chip-On-Film technology.

### BACKGROUND OF THE INVENTION

Application fields of a camera module are wide, such as digital camera, video telephone, video conference system. Normally the camera module includes a package having an image sensing chip (such as CMOS) inside an optical device for capturing image information. The camera module is converting the image information to the digital signal and transporting to a circuit board for identifying or storing the image information.

A conventional CCD image sensing module was disclosed in R.O.C. Taiwan Patent No. 492593 entitled “CCD and CMOS image capturing module”. The CCD and CMOS image capturing module comprises a image sensing device which is electrically connecting to a circuit board. A lens holder is mounted on the circuit board and seals the image sensing device. Because that the circuit board forms a module circuit which is for connecting to the image sensing device, the process flow of the CCD and CMOS image capturing module is that firstly connecting the image sensing device to the circuit board, then fixing the lens holder and the circuit board. The CCD and CMOS image capturing module would cause the lens holder and the image sensing device misalignment, and capturing angle of the image sensing device is easy to deviate. Another improved structure of the CCD and CMOS image capturing module which is similar to the foregoing CCD and CMOS image capturing module are brought from the known patent. But the lens holder is connecting onto mold body of the image sensing device (CMOS or CCD). Besides, the lens holder is attached and sealed the top edge of the mold body of the image sensing device. However, the lens holder is connecting on the image sensing device, the image sensing device has to sustain the weight of the whole lens holder. The stability between the image sensing device and circuit board would be poor.

Another conventional electric camera lens module was disclosed in R.O.C Taiwan. Patent No. 372079 entitled “electric camera lens module”. The electric camera lens module comprises a lens holder and a photosensitive module, wherein a plane of the lens holder disposes a hollow pillar which is set an adjustable cone, another plane of the lens holder disposes a trough which is linking the hollow pillar. The photosensitive module is installed in the trough, which comprises a filter, a hard substrate with pins and a photosensitive chip, wherein the substrate has a through hole at corresponding the hollow pillar for setting the filter. The photosensitive chip has a photosensitive surface corresponding to the through hole and the pillar, and has a plurality of contact ends contacted with pins of the substrate through the signal circuit of the substrate. When the pins electrically contact with an exterior electronic device, the electric camera lens module will start to capture image. Because of the photosensitive module is assembled by the filter, the hard substrate and the photosensitive chip, wherein the photosensitive chip is disposed at the bottom of the substrate in bare-chip configuration, so that protection of the photosensitive chip is poor. The whole thickness of the electric camera lens module is thicker, because the thickness of the photosensitive module has to consider the thickness of the filter, the hard substrate and the photosensitive chip, and the length of the pins of the hard substrate.

### SUMMARY

The primary object of the present invention is to provide a thin type camera module comprises an image-sensing semiconductor assembly which is manufacture by a chip-on-film (COF) packaging method, so the thin type camera module is thinner. Besides, a fixing board forms a recession for holding an image sensing chip in order to achieve more thinner thin type camera module.

The second object of the present invention is to provide a thin type camera module comprises an image-sensing semiconductor assembly which is manufacture by a COF packaging method. An image sensing chip is flip-chip mounted on a COF wiring film, so the reliability is better. And the COF wiring film is suited for continue mass production the image-sensing semiconductor assembly to reduce the thin type camera module running cost.

The third object of the present invention is to provide a thin type camera module comprises an image-sensing semiconductor assembly with a COF wiring film. The COF wiring film possesses all circuit design including module circuit for the thin type camera module to integrate a module circuit of the thin type camera module in the image-sensing semiconductor assembly so that an extra circuit substrate is not necessary. The COF wiring film with module circuit has input/output terminals directly to let image-sensing semiconductor assembly enables mounting of passive element. The image-sensing semiconductor assembly could be connected to a fixing board or a lens holder firstly for variedly process flow.

According to the thin type camera module of the present invention, which comprises a fixing board, an image-sensing semiconductor assembly and a lens holder. The image-sensing semiconductor assembly comprises a COF wiring film and an image sensing chip. The the COF wiring film forms a plurality of connecting ends around a window of the COF wiring film for flip-chip connecting. The connecting ends is disposed on a surface of the COF wiring film. The image sensing chip has a photosensitive surface with a plurality of bumps. The image sensing chip is flip-chip mounted to the COF wiring film by electrically connecting the bumps and the connecting ends, and the photosensitive surface of the image sensing chip is corresponding to the window of the COF wiring film. Preferably, the COF wiring film includes a module circuit for connecting passive element what the thin type camera module need. The lens holder is mounted on the fixing board to form an airtight space. The image sensing chip locates inside the airtight space and the photosensitive surface of the image sensing chip is toward a light-pervious channel of the lens holder for capturing image.

### DESCRIPTION OF THE DRAWINGS

FIG. 1 is a cross-sectional view illustrating a thin type camera module of a first embodiment of the present invention.

FIG. 2 is a cross-sectional view illustrating an image-sensing semiconductor assembly of the thin type camera module of the first embodiment of the present invention.

FIG. 3 is a process flow chart of the thin type camera module of the first embodiment of the present invention.

FIG. 4 is a cross-sectional view illustrating a thin type camera module of a second embodiment of the present invention.

FIG. 5 is a cross-sectional view illustrating an image-sensing semiconductor assembly of the thin type camera module of the second embodiment of the present invention.

### DEATAILED DESCRIPTION OF THE PRESENT INVENTION

Referring to the drawings attached, the present invention will be described by means of the embodiments below.

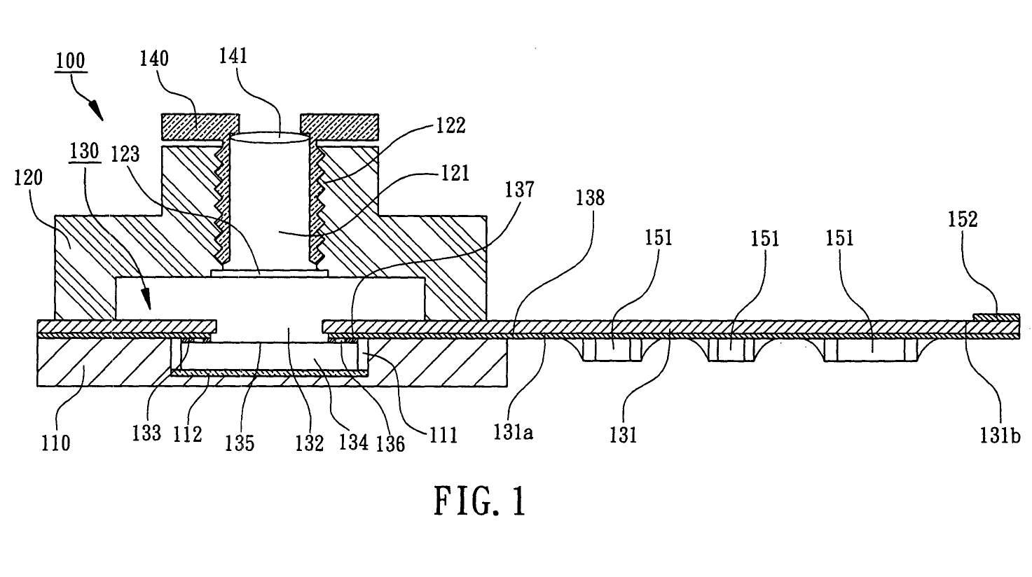

As showed in FIG. 1, a thin type camera module 100 of a first embodiment of the present invention comprises a fixing board 110, a lens holder 120 and an imaging-sensing semiconductor assembly 130, wherein the fixing board 110 is a kind of hard material without electrical transmitting function, such as BT substrate, FR-4 substrate, ceramic substrate or metal plate. The lens holder 120 is mounted on the fixing board 110 to form an airtight space to fix the imaging-sensing semiconductor assembly 130. The lens holder 120 has a light-pervious channel 121 which forms a connecting portion 122, such as inner thread of a screw, at a opening of the light-pervious channel 121 for connecting a camera lens 140. The camera lens 140 has a lens 141 and its shape is like a cylindrical. The camera lens 140 is fixed or connected to the lens holder 120 in adjustable type.

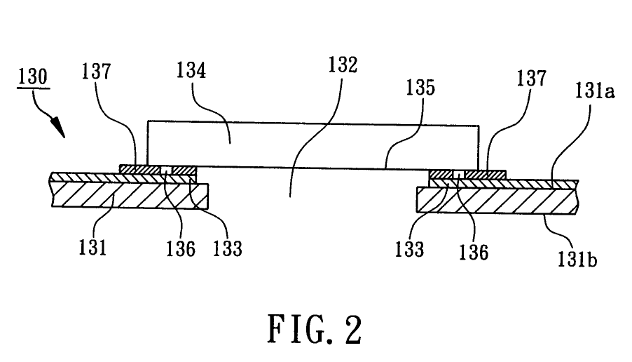

Referring to FIGS. 1 and 2, the imaging-sensing semiconductor assembly 130 comprises a COF (chip-on film) wiring film 131 and an image sensing chip 134, wherein the COF wiring film 131 is flexible, such as polyimide (PI). The COF wiring film 131 has a first surface 131a, a second surface 131b and a window 132. The window 132 is passing through the first surface 131a and the second surface 131b. In this embodiment, the COF wiring film 131 has a plurality of metal wires forming on the first surface 131a. The metal wires has a plurality of connecting ends 133 which are disposed around the window 132 on the first surface 131a of the COF wiring film 131. The image sensing chip 134 is optical sensing chip, CCD (charge coupled device), CMOS (complementary metal oxide semiconductor) or photodiode, which is having a photosensitive surface 135. A plurality of bumps 136, such as gold bumps, are formed on peripherals of the photosensitive surface 135 for output terminals of the image sensing chip 134. The image sensing chip 134 is flip-chip mounted on the COF wiring film 131, and its photosensitive surface 135 is corresponding to the window 132 and the bumps 136 are electrically connected with the connecting ends 133. Preferably, a sealant layer 137, such as ACF (anisotropic conductive film), NCF (non-conductive film), UV past or thermosetting filling past, is disposed around the window 132 of the COF wiring film 131 between the first surface 131a of the COF wiring film 131 and the photosensitive surface 135 of the image sensing chip 134. The sealant layer 137 encloses the bumps 136 of the image sensing chip 134 and combines the COF wiring film 131 with the image sensing chip 134 for improving reliability of electrically connecting of the connecting ends 133 and the bumps 136.

The image sensing chip 134 is disposed inside the airtight space which is formed by the lens holder 120 and the fixing board 110. Inside the airtight space, it can be vacuum state or inert gas filled, such as Nitrogen or Argon gas, for avoiding moisture invading and effecting the image sensing chip 134 capturing image. In this embodiment, the fixing board 110 forms a recession 111. The image sensing chip 134 is attaching on the recession by an adhesive layer 112 (such as past or tape) which is formed at bottom surface of the image sensing chip 134. The recession 111 assists the image sensing chip 134 in locating for aligning with the photosensitive surface 135 and the light-pervious channel 121 of the lens holder 120. Perfectly, the lens holder 120 disposes a filter 123 which is also aligning with the light-pervious channel 121 and corresponding to the photosensitive surface 135 of the image sensing chip 134. The filter 123 is used for filtering out the infrared in order to avoid causing noise or false color. Besides, the COF wiring film 131 includes a module circuit 138 which is formed on extending surface which is not covered by the lens holder 120. The module circuit 138 is electrically connecting at least an electric device 151, such as a passive component (selected from resistant, inductance and capacitance) or a active component. A plurality of connection fingers 152 are connected with the module circuit 138 of the COF wiring film 131 and the image sensing chip 134, which are used for input/output terminals of the whole thin type camera module 100 for electrically connecting to exterior electrical device.

The imaging-sensing semiconductor assembly 130 of the thin type camera module 100 of the present invention is manufactured by a Chip-On-Film (COF) packaging method. The thin type camera module is thinner and suited for continuously mass producing the image-sensing semiconductor assemblies to reduce the thin type camera module running cost. The image sensing chip 134 is flip-chip mounted on the COF wiring film 131. The connecting ends 133 of the COF wiring film 131, which are disposed surrounding the window 132 on the first surface 131a for better stability of the image sensing chip 134. And, the fixing board 110 forms the recession 111 for installing the image sensing chip 134 and achieve forming a thinner thin type camera module 100. In addition, the COF wiring film 131 of imaging-sensing semiconductor assembly 130 can provide all circuit design of the thin type camera module 100 to integrating the module circuit 138 of the image-sensing semiconductor assembly 130. And the COF wiring film 131 is formed input/output terminals directly, so the hard circuit substrate is not necessary. The COF wiring film 131 with the module circuit 138, which is flexible and exposing out of the lens holder 120, so process flow of the thin type of camera module 100 is various. The image-sensing semiconductor assembly 130 could be connected to the fixing board 110 or the lens holder 120 at first base on process flow design to achieve elastic process flow because that the image-sensing semiconductor assembly 130 is not necessary to electrically connect to the lens holder 120 and the fixing board 110.

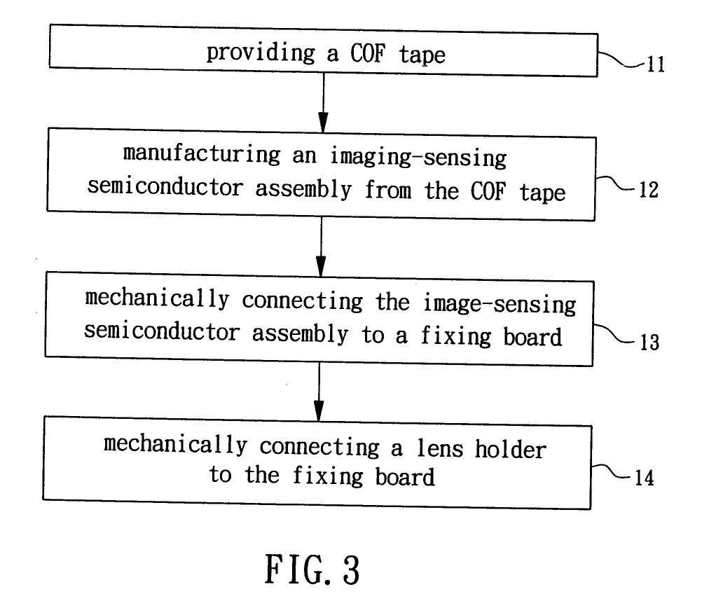

One of manufacturing process flows for the thin type camera module 100 of above description is shown in FIG. 3. The detailed description of the process flow of the thin type camera module 100 is as following:

Firstly, a COF tape is provided in a step 11 of “providing a COF tape”. The COF tape is rolled in the reel, which comprises a plurality of mentioned-above COF wiring films 131. Each first surface 131a of the COF wiring film 131 forms a plurality of metal wires which include a plurality of connecting ends 133 disposed around the window 132 on the first surface 131a. Preferably, the metal wires are connecting with the module circuit 138.

Then, the imaging-sensing semiconductor assembly 130 is manufactured by a COF packaging method in a step 12 of “manufacturing an imaging-sensing semiconductor assembly from the COF tape”. Peripherals of the photosensitive surface 135 of the image sensing chip 134 are a plurality bumps 136 which are non-reflowable conductive bumps such as gold, copper, aluminum or its alloy, or solder bumps. In this embodiment, the bumps 136 are gold bumps for flip-chip mounted to the COF tape. Then, he image sensing chips 134 are flip-chip mounted to the COF tape. Preferably, prior to the flip-chip mounting step, a sealant layer 137 such as an ACF or a NCF is coated. The photosensitive surface 135 of the image sensing chip 134 is corresponding the window 132 and face down, and the face surface 131a of the COF wiring film 131 is face up for flip-chip mounting the image sensing chip 134 on the COF wiring film 131. In one embodiment, the sealant layer 137 is an ACF, the bumps 136 could not be necessary to bond with the connecting ends 133 actually. The bumps 136 are electrically connected to the connecting ends 133 vertically by conductive particles of the ACF sealant layer 137. The sealant layer 137 encloses the bumps 136 for protecting the bumps and improving reliability of electrically connecting of the connecting ends 133 and the bumps 136. Perfectly, at least an electric device 151 is surface-mounted to the module circuit 138 of the COF wiring film 131 for constututing whole module circuit 138 and electrical functions in the imaging-sensing semiconductor assembly 130. So the COF tape can package the pluralities of image-sensing semiconductor assemblies 130 continuously, then the COF tape is singulated to get image-sensing semiconductor assemblies 130 for next step of process flow of the thin type camera module 100.

Then, the image-sensing semiconductor assembly 130 is fixed to the fixing board 110 in a step 13 “mechanically connecting the image-sensing semiconductor assembly to a fixing board”. The fixing board 110 has a recession 111. The adhesive layer 112 is prepared in the recession 111 for adhering the image sensing chip 134. The recession 111 assists the image sensing chip 134 in fixing the image sensing chip 134 and the capturing angle in position, meanwhile, providing a thinner module.

Then, the lens holder 120 is connecting to the fixing board 110 to form an airtight space in a step 14 of “mechanically connecting a lens holder to the fixing board”. The image sensing chip 134 is located inside the airtight space for avoiding dust invading it. The lens holder 120 has a light-pervious channel 121 which is connecting a camera lens 140 at a opening of the light-pervious channel 121. Preferably, the lens holder 120 includes a filter 123 which is aligning with the light-pervious channel 121. The photosensitive surface 135 of the image sensing chip 134, the filter 123 of the lens holder 120 and the lens 141 of the camera lens 140 are forming on the light-pervious channel 121 and corresponding each other for capturing image. In the process flow of the thin type camera module 100 of above description, the image-sensing semiconductor assembly 130 is located on the fixing board 110 and the recession 111 of the fixing board 110 assists the image sensing chip 134 in locating for the photosensitive surface 135 of the image sensing chip 134 corresponding to the filter 123 and lens 141 in order to align correctly and get right capturing angle.

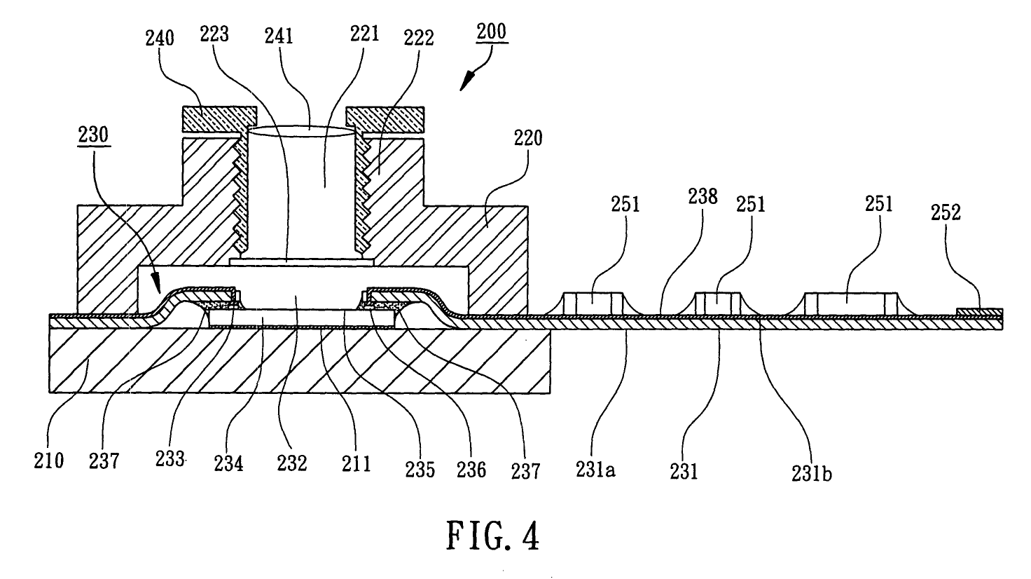

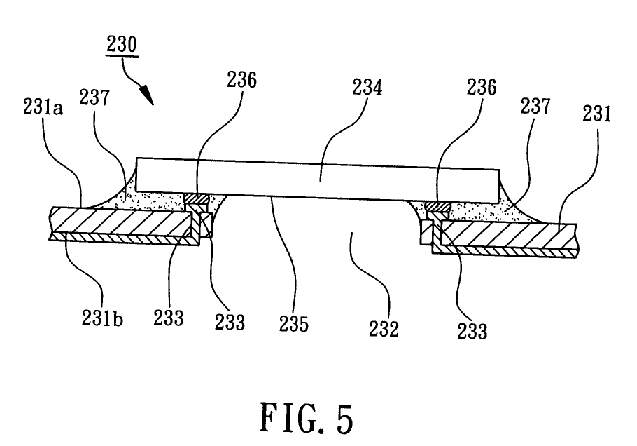

As showed in FIG. 4, a thin type camera module 200 of a second embodiment of the present invention comprises a fixing board 210, a lens holder 220 and an imaging-sensing semiconductor assembly 230, wherein the fixing board 210 is a kind of hard substrate without electrical function. The lens holder 220 is mounted on the fixing board 210 to form an airtight space. The lens holder 220 has a light-pervious channel 221 which forms a connecting portion 222 for connecting a camera lens 240. The imaging-sensing semiconductor assembly 230 comprises a COF wiring film 231 and an image sensing chip 134. The image sensing chip 134 is disposed insides the airtight space. The COF wiring film 231 has a first surface 231a, a second surface 231b, a window 232 which passes through the first surface 231a and the second surface 231b, and at least a conductive via 239 disposed around the window 232. In this embodiment, the COF wiring film 231 has a plurality of metal wires forming on the second surface 231b. The metal wires includes a plurality of connecting ends 233 disposed on the first surface 231a around the window 232. The conductive vias 239 electrically connect the connecting ends 233. Surrounding the photosensitive surface 235 of the image sensing chip 234 are a plurality of bumps 236. In this embodiment, the bumps 236 are reflowable solder bumps. FIG. 5 is a cross-section view illustrating of the imaging-sensing semiconductor assembly 230 after manufactured by a chip-on-film packaging method. The photosensitive surface 235 of the image sensing chip 234 is face-down and corresponding to the window 232 of the COF wiring film 231 during flip-chip mounting step. The first surface 231a of the COF wiring film 231 is face-up and the image sensing chip 234 is flip-chip mounted on the COF wiring film 231. The bumps 236 electrically connect the connecting ends 233. Preferably, a sealant layer 237 is formed surrounding the windows 232 of the COF wiring film 231 after flip-chip mounting. In this embodiment, the sealant layer 237 is a thermosetting compound such as UV past, transparent thermosetting liquid compoundt or underfilling material. The sealant layer 237 fills the surrounding of the photosensitive surface 235 of the image sensing chip 234 by capillarity, but it is not covering the active area of the photosensitive surface 235. The sealant layer 237 encloses the bumps 236 for fixing the image sensing chip 234 and the COF wiring film 231 and for improving reliability of electrically connecting of the connecting ends 233 and the bumps 236.

In this embodiment, thickness of the image sensing chip 234 is thinner by grinding bottom surface of the image sensing chip 234 for providing a thinner module and a better horizontal plane corresponding to the photosensitive surface 235. When the image sensing chip 234 of the imaging-sensing semiconductor assembly 230 is disposed inside the airtight space which is formed by the lens holder 220 and the fixing board 210, an adhesive layer 211 (such as past or tape) is formed between the bottom surface of the image sensing chip 234 and the fixing board 210 for fixing the image sensing chip 234 on the fixing board 210. The image sensing chip 234 is steadier and having a steady capturing angle. The photosensitive surface 235 of image sensing chip 234 is aligning with the light-pervious channel 221 of the lens holder 220. The lens holder 220 comprises a filter 223 which is also aligning with the light-pervious channel 221 and corresponding to the photosensitive surface 235 of the image sensing chip 234. The photosensitive surface 235 of the image sensing chip 234, the filter 223 of the lens holder 220 and the lens 241 of the camera lens 240 are forming in the light-pervious channel 221 and corresponding each other for capturing image. In addition, the metal wires of the COF wiring film 231 includes a module circuit 238 for electrically mounting at least a passive component 251 of the thin type camera module 200 in the imaging-sensing semiconductor assembly 230. The module circuit 238 is formed on an extended surface of the fixing board 210 which is not covered by the lens holder 220 for electrically connecting the electric device 251. Connection fingers 252 are connected with the module circuit 238 of the COF wiring film 231 and the image sensing chip 234, which are used for input/output terminals of the whole thin type camera module 200.

Therefore, thickness of the thin type camera module 200 is thinner. The imaging-sensing semiconductor assembly 230 of the thin type camera module 200 is suited for continuously mass production to reduce the thin type camera module running cost.

The whole circuit patterns of the thin type camera module 200 are integrated in the imaging-sensing semiconductor assembly 230 with module circuit 238, so the extra module substrate is not necessary. The COF wiring film 231 with module circuit 238 is flexible and partially exposed out of the lens holder 220. The image-sensing semiconductor assembly 230 could be mechanically connected to the fixing board 210 or the lens holder 220 elastically for varieous process flow of the thin type camera module 200.

The above description of embodiments of this invention is intended to be illustrated and not limiting. Other embodiments of this invention will be obvious to those skilled in the art in view of the above disclosure.

What is claimed is:

1. A thin type camera module comprising:
a fixing board;
an imaging-sensing semiconductor assembly comprising a COF (chip-on film) wiring film and an image sensing chip, wherein the COF wiring film has a surface, a window and a plurality of connecting ends disposed on the surface of the COF wiring film around the window, the image sensing chip has a photosensitive surface corresponding to the window, and a plurality of bumps are formed on peripherals of the photosensitive surface, the image sensing chip is flip-chip mounted on the COF wiring film to electrically connect the bumps with the connecting ends; and
a lens holder for connecting a camera lens, wherein the lens holder has a light-pervious channel and is connected with the fixing board to form a airtight space for sealing the image sensing chip, and the photosensitive surface of the image sensing chip is corresponding to the light-pervious channel for capturing image.

2. The thin type camera module in accordance with claim 1, further comprising at least an electric device electrically connected with the COF wiring film.

3. The thin type camera module in accordance with claim 2, wherein the electric device is a passive component.

4. The thin type camera module in accordance with claim 2, wherein the COF wiring film formed a module circuit electrically connecting the electric device.

5. The thin type camera module in accordance with claim 4, wherein the module circuit is formed on an extending surface of the COF wiring film without being covered by the lens holder.

6. The thin type camera module in accordance with claim 1, further comporising a sealant layer is formed around the window of the COF wiring film for enclosing the bumps of the image sensing chip.

7. The thin type camera module in accordance with claim 6, wherein the sealant layer is an anisotropic conductive film (ACF).

8. The thin type camera module in accordance with claim 6, wherein the sealant layer is a non-conductive film (NCF).

9. The thin type camera module in accordance with claim 6, wherein the sealant layer is transparent thermosetting compound.

10. The thin type camera module in accordance with claim 1, wherein the COF wiring film has at least a conductive via electrically connecting the connecting ends.

11. The thin type camera module in accordance with claim 1, wherein the lens holder comprises a filter aligning with the light-pervious channel.

12. The thin type camera module in accordance with claim 1, further comprising a camera lens connected with the lens holder.

13. The thin type camera module in accordance with claim 1, wherein the fixing board has a recession for locating the image sensing chip.

14. The thin type camera module in accordance with claim 1, wherein the airtight space is in vacuum state.

15. The thin type camera module in accordance with claim 1, wherein the airtight space filled with inert gas.
